(19) United States
(12) Patent Application Publication
(10) Pub. No.: US 2026/0145979 A1
(43) Pub. Date: May 28, 2026

(54) ROTARY BATCH AND CULLET PREHEATER SYSTEM CONTROL SCHEME

(71) Applicant: Jeffrey C. Alexander, Newbury, MA (US)

(72) Inventor: Jeffrey C. Alexander, Newbury, MA (US)

(21) Appl. No.: 19/385,531

(22) Filed: Nov. 11, 2025

Related U.S. Application Data
(60) Provisional application No. 63/725,139, filed on Nov. 26, 2024.

(51) Int. Cl. C03B 3/02

(52) U.S. Cl. CPC C03B 3/023

(57) ABSTRACT

Control system and method for controlling the amount of material fed to a glass furnace from a rotatable chamber of a rotary heat-exchanger having a rotatable chamber variable frequency drive in communication with a rotatable chamber motor for rotating said rotatable chamber. The control system may include a material feeder in communication with the rotatable chamber; a driver for the material feeder including a feeder variable frequency drive and a feeder motor associated with the feeder variable frequency drive; a controller in communication with the feeder variable frequency drive and with the chamber variable frequency drive and configured to modify the speed of the material feeder in response to a signal generated by the chamber variable frequency drive indicative of a torque required to rotate the rotatable chamber.

This application claims priority of U.S. provisional application Ser. No. 63/725,139 filed on Nov. 26, 2024, the disclosure of which is hereby incorporated by reference in its entirety.

### BACKGROUND OF THE INVENTION

Embodiments disclosed herein relate to a method for preheating raw materials for glass manufacture using waste heat from the glass melting process.

Glass is made by heating and melting a mixture of solid raw materials to a liquid state. The melting is done inside of a furnace and necessarily requires substantial amounts of heat. Typically, this heat is generated by the combustion of fossil fuels and the exhaust gases from the combustion leave the furnace. Exhaust gas temperatures immediately after the furnace are quite high, typically 1350-1450° C. In some cases, combustion air preheaters are included which recover some of the heat in these gases. Even so, gas temperatures at the discharge to atmosphere are quite high, thus substantial amounts of heat are wasted. The cost of fuel for heating the furnace is a major component in the cost of making glass.

The raw materials for glass are typically referred to as batch and cullet. The word batch generally refers to an assemblage of various pulverous materials including silica sand, limestone, soda ash, salt cake, and a variety of other minor ingredients. The material and mixture ratios are carefully chosen to produce glass of the desired properties and quality. Generally, these materials are prepared in a finely divided form to promote their melting rates. Sizes are typically 100 to 200 μm diameter with a maximum size of 1 mm.

The word cullet generally refers to recycled glass, either from the factory or from external sources. Cullet from the factory is typically less than 10% of the production rate of the furnace and is generated by product breakage, or product rejected due to defects. Factory cullet is gathered from the various sources in the plant, crushed to sizes less than 100 mm and collected in a central storage hopper.

Cullet from external sources, referred to as Post-Consumer Recycle (PCR) cullet generally comes from glass bottle recycling programs in the community. The amount of PCR cullet in each furnace can vary widely, from as little as 0% of production rate up to 80%. PCR cullet is generally laden with impurities such as organic residues, paper, plastics, and other non-glass materials deposited into recycling containers. PCR cullet is delivered to the glass factory by truck or rail carriers from the recycling centers. PCR cullet is normally delivered in a coarse crushed form of size less than 100 mm.

The batch, factory cullet and PCR cullet are typically blended before introduction to the melting furnace.

Embodiments disclosed herein can be advantageously used to preheat the batch and the cullet using heat from exhaust gases such as those from the combustion of fossil fuel(s) typically resulting from the production of glass, and results in an improved glass melting process. By preheating these materials before they are introduced to the furnace, the amount of fuel required for heating and melting them can be reduced. This fuel reduction can represent a substantial economic benefit to the glass making process and reduces the emission of harmful gases (such as NOx and CO₂) simply because less fuel is burned.

Fossil fuel fired glass furnaces are of several different designs. When air is combusted with fuel, the air is typically preheated in regenerative or recuperative heat exchangers to preheat the combustion air utilizing some of the waste heat exiting the furnace. When nominally pure oxygen is used for combustion, no waste heat recovery equipment is typically involved. Such furnaces are termed oxyfuel fired.

While embodiments disclosed herein could be advantageously applied to any of the glass production schemes, its benefits are greatest in the case of oxyfuel fired furnaces. This is because exhaust gas temperatures are higher, thus batch and cullet can be preheated to high temperatures, and because reduction in fuel requirements for the furnace is accompanied by a proportional reduction in the oxygen supply (and thus cost) for the furnace.

### SUMMARY

Embodiments disclosed here are an improvement over embodiments disclosed in U.S. Pat. No. 12,084,375 entitled “Rotary Batch and Cullet Preheater System and Method”, the disclosure of which is hereby incorporated by reference.

In certain embodiments, the rotary batch and cullet preheater system may be comprised of:
1. Gas Inlet and outlet plenums to direct hot gases through a heat exchanger in a rotatable chamber, the heat exchanger preferably having one or more heat exchanger tubes;
2. The rotatable chamber configured to contain a quantity of the material to be heated, said rotatable chamber including:
   a. a heat exchanger having one or more tubes for hot gases to flow through, heat being transferred from the hot gases, through one or more tube walls of the one or more tubes and into the material in the rotatable chamber, and one or more shovels to aid in the discharge of material from the rotatable chamber;
   b. a driver such as a motor with associated equipment to rotate the rotatable chamber;
   c. a controller to control the speed of the rotatable chamber driver, configured to accept an electrical signal proportional to the desired speed of the driver; and
   d. a device configured to provide an electrical signal proportional to the torque required to rotate the rotatable chamber;
3. An infeed hopper periodically supplied with material to be heated from a source of material.
4. An infeed feeder such as a screw feeder, configured to receive material from said infeed hopper and to discharge material to the interior of the rotatable chamber, said feeder including, in certain embodiments:
   a. a rotatable auger, and
   b. a feeder driver such as a motor with associated equipment to rotate the auger, and
   c. a controller to control the speed of the feeder driver (and thus the feeder/rotatable auger), configured to accept an electrical signal proportional to the desired speed of the feeder driver;
5. A discharge hopper to receive material from the rotatable chamber, including:
   a. a device to determine the level of material in the discharge hopper and provide an electrical signal proportional to that level;
6. A process feeder configured to receive material from said discharge hopper and discharge material to a glass furnace, including, in certain embodiments:
   a. mechanical equipment with driving equipment (e.g., a furnace driver feeder) to feed material into the furnace, and
   b. a controller to control the driving equipment, configured to accept an electrical signal proportional to the desired speed or intensity of the driving equipment;
7. A process container, in certain embodiments a glass furnace, including:
   a. a device to determine the level of material in the process container and provide an electrical signal proportional to that level; and
   b. a controller configured to accept the electrical signal (e.g., in electrical communication with the device to determine the level of material) and regulate the amount of material introduced into the process container.

In certain embodiments, the control system may be comprised of one or more of:
a. A Control Loop for controlling the amount of material inside a rotatable chamber, in certain embodiments the Control Loop having:
   i. Process Variable (PV)=Rotatable Chamber Torque (torque being a proxy for the material level in the rotatable chamber)
   ii. Control Variable (CV)=Infeed Speed
   iii. Set Point (SP)=Value of Rotatable Chamber Torque that corresponds to a desired, predetermined or optimum fill level of the rotatable chamber (e.g., this optimum fill level may be a level in the rotatable chamber as high as possible without resulting in the infeed being blocked, which can be determined, for example, by trial-and-error or known from prior experience).
b. A Control Loop configured to control the amount of material inside the discharge hopper, in certain embodiments this Control Loop having:
   i. Process Variable (PV)=Discharge Hopper Material Level
   ii. Control Variable (CV)=Rotatable Chamber Motor Speed (i.e., the rotational speed of the rotatable chamber)
   iii. Set Point (SP)=Value Discharge Hopper Level corresponding to a desired, predetermined or optimum fill level (e.g., this optimum fill level in the discharge hopper may be a level greater than zero and less than the amount that blocks the discharge into the rotatable chamber, which can be determined, for example, by trial-and-error or known from prior experience).
c. A Control Loop also configured to control the amount of product glass material in the glass furnace, in certain embodiments having:
   i. Process Variable (PV)=Glass Level in Furnace
   ii. Control Variable (CV)=Speed or Intensity of Driving Equipment for the glass furnace Process Feeder.
   iii. Set Point (SP)=Value of Glass Level corresponding to a desired, predetermined or optimum level (the optimum level is fundamental to the design of the glass furnace and is determined by the designer in advance of construction, as known in the art).

Accordingly, certain embodiments relate to a control system or systems for controlling the amount of material fed to a glass furnace from a rotatable chamber of a rotary heat-exchanger having a rotatable chamber variable frequency drive in communication with a rotatable chamber motor for rotating said rotatable chamber, the control system comprising:
a material feeder in communication with said rotatable chamber;
a driver for said material feeder including a feeder variable frequency drive and a feeder motor associated with the feeder variable frequency drive;
a controller in communication with said feeder variable frequency drive and with said chamber variable frequency drive and configured to modify the speed of said material feeder in response to a signal generated by said chamber variable frequency drive indicative of a torque required to rotate said rotatable chamber.

Certain embodiments relate to a control system for controlling the amount of material fed to a glass furnace from a rotatable chamber of a rotary heat-exchanger wherein a discharge hopper is in communication with said rotatable chamber and with said glass furnace, said control system comprising:
a hopper level measurer configured to measure the level of said material in said discharge hopper;
wherein said controller is in communication with said hopper level measurer and with said rotatable chamber variable frequency drive and is configured to modify the speed of said rotatable chamber in response to a signal generated by said hopper level measurer indicative of the level of said material in said discharge hopper.

This latter control system may be used in combination with the first control system described above.

In some embodiments, either or both of the aforementioned control systems may further comprise:
a glass furnace measure leveler configured to measure the level of said material in said glass furnace; and
a glass furnace feeder in communication with said discharge hopper and with said glass furnace and having a glass furnace feeder driver;
wherein said controller is in communication with said glass furnace level measurer and with said glass furnace feeder driver and is configured to modify the speed of said glass furnace feeder driver in response to a signal generated by said glass furnace measure leveler indicative of the level of said material in said glass furnace.

Also disclosed are methods for controlling the amount of material fed to a glass furnace from a rotatable chamber of a rotary heat-exchanger having a rotatable chamber variable frequency drive in communication with a rotatable chamber motor for rotating the rotatable chamber. In certain embodiments the method comprises:
generating a signal with the chamber variable frequency drive indicative of a torque required to rotate the rotatable chamber;
driving a material feeder having a feeder variable frequency drive and a motor associated with the variable frequency drive to feed the material into the rotatable chamber;
controlling the speed of the material feeder with the variable frequency drive in response to the sensed signal indicative of the torque.

In certain embodiments, a discharge hopper is in communication with the rotatable chamber and with the glass furnace, and the method further comprises:
measuring the level of the material in the discharge hopper; and
controlling the speed of the rotatable chamber in response to a signal generated by the hopper level measurer indicative of the level of the material in the discharge hopper by controlling the chamber variable frequency drive.

In certain embodiments, either or both of the aforementioned methods may further comprise:

measuring the level of the material in the glass furnace; and

feeding the material into the glass furnace with a glass furnace feeder in communication with the discharge hopper and with the glass furnace, the glass furnace feeder having a glass furnace feeder driver; and
controlling the speed of the glass furnace feeder driver in response to the measured level of material in the glass furnace.

In certain embodiments, disclosed is a method for controlling the amount of material fed to a glass furnace from a rotatable chamber of a rotary heat-exchanger wherein a discharge hopper is in communication with the rotatable chamber having a rotatable chamber variable frequency drive in communication with a rotatable chamber motor for rotating the rotatable chamber and is in communication with the glass furnace. In certain embodiments the method comprises:
measuring the level of the material in the discharge hopper; and
controlling the speed of the rotatable chamber in response to a signal generated by the hopper level measurer indicative of the level of the material in the discharge hopper by controlling the chamber variable frequency drive.

In certain embodiments, this method may further comprise:
measuring the level of the material in the glass furnace; and
feeding the material into the glass furnace with a glass furnace feeder in communication with the discharge hopper and with the glass furnace, the glass furnace feeder having a glass furnace feeder driver; and controlling the speed of the glass furnace feeder driver in response to the measured level of material in the glass furnace.

Those skilled in the art appreciate in certain embodiments, one or more controllers may be used, and each controller may be a PID (proportional-integral-derivative) controller. A PID controller is an instrument that receives input data (e.g., from sensors (e.g., is in electrical communication with sensors)), calculates the difference between the actual value and a desired setpoint, and adjusts outputs to control variables. It does this through three mechanisms: proportional control, which reacts to current error; integral control, which addresses accumulated past errors; and derivative control, which predicts future errors. The PID controller sums those three components to compute the output. Thus, in a PID control system, a Process Variable (PV) is the actual measured value of a system parameter being controlled, a Control Variable (CV) is the output signal that the PID controller adjusts to influence the Process Variable, and the Set Point (SP) is the desired or target value that the Process Variable should reach and maintain.

For any such control system disclosed herein, a suitable controller may be used, such as a controller having a processing unit and a storage element. The processing unit may be a general-purpose computing device such as a microprocessor. Alternatively, it may be a specialized processing device, such as a programmable logic controller (PLC) or a proportional-integral-derivative controller (PID). The storage element may utilize any memory technology, such as RAM, DRAM, ROM, Flash ROM, EEROM, NVRAM, magnetic media, or any other medium suitable to hold computer readable data and instructions. The controller unit may be in electrical communication (e.g., wired, wirelessly) with one or more of the operating units in the system, including one or more actuators, sensors, motors, etc. The controller also may be associated with a human machine interface or HMI that displays or otherwise indicates to an operator one or more of the parameters involved in operating the system and/or carrying out the methods described herein. The storage element may contain instructions, which when executed by the processing unit, enable the system to perform the functions described herein. In some embodiments, more than one controller may be used.

In certain embodiments, the three aforementioned control systems are cascaded.

In certain embodiments, of primary importance is the maintenance of the glass level in the glass furnace to assure proper function of downstream production equipment. Accordingly, during operation the furnace driver feeder should always have material available to it, e.g., the discharge hopper level must be maintained at a certain level so that it does not fall too low, and should not be too high so that it blocks material discharge from the rotatable chamber).

In certain embodiments, it also is important to maintain a proper material level in the rotatable chamber to optimize heat transfer to the material in the rotatable chamber, and to ensure that the rotatable chamber is not overfilled with material to so as to avoid blocking the infeed.

In certain embodiments, the operation logic is:
a. Glass furnace feeder driver will vary to maintain constant glass level in the glass furnace, causing the discharge hopper level to vary;
b. Rotatable chamber rotational speed will then vary to maintain constant discharge hopper level, causing the rotatable chamber material level to vary; and
c. Infeed rate will vary to maintain a constant rotational chamber material level.

With all three of the aforementioned control systems functioning, the material level in the glass furnace will remain constant; the discharge hopper level will remain constant; and the rotational chamber material level will remain constant.

### BRIEF DESCRIPTION OF THE DRAWINGS

The above and other aspects of the embodiments disclosed herein will now be described in further detail, by way of example only, with reference to the accompanying drawings, in which:

FIG. 1 is a flow diagram of a method for control of a Rotating Batch and Cullet Preheater System in accordance with certain embodiments;

FIG. 2A is a cross-sectional side view of a rotatable chamber showing material fill inside in accordance with certain embodiments;

FIG. 2B is a cross-section view showing a plurality of shovels in accordance with certain embodiments;

FIGS. 3A and 3B are cross-sectional views of a rotatable chamber showing material fill inside in accordance with certain embodiments;

FIG. 4 is a graph of the material quantity in a rotatable chamber vs. the rotation drive motor torque for a typical sized device in accordance with certain embodiments; and

FIG. 5 is a graph of the material quantity in a rotatable chamber vs. the depth of material for a typical sized device in accordance with certain embodiments.

### DETAILED DESCRIPTION

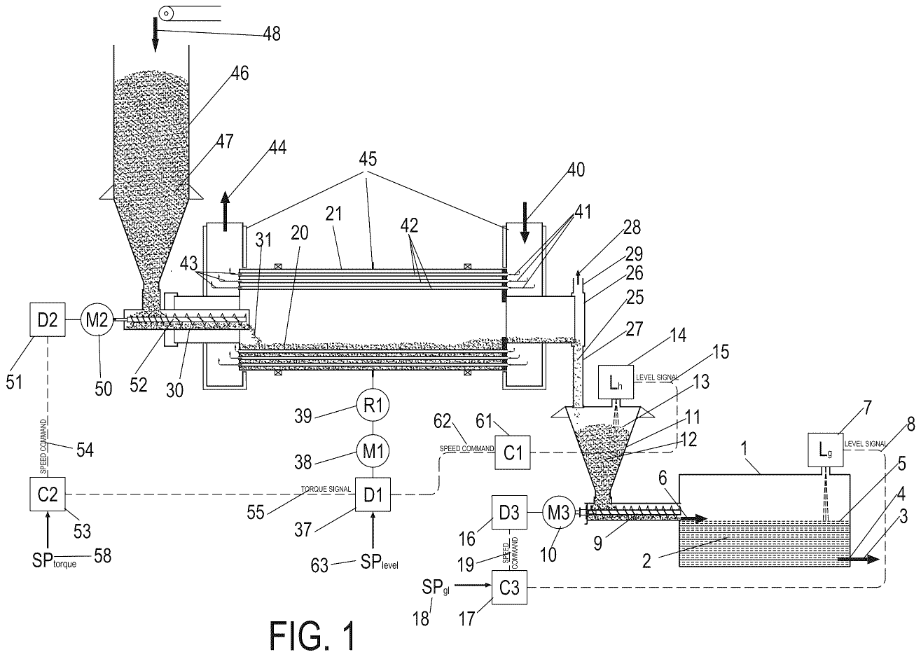

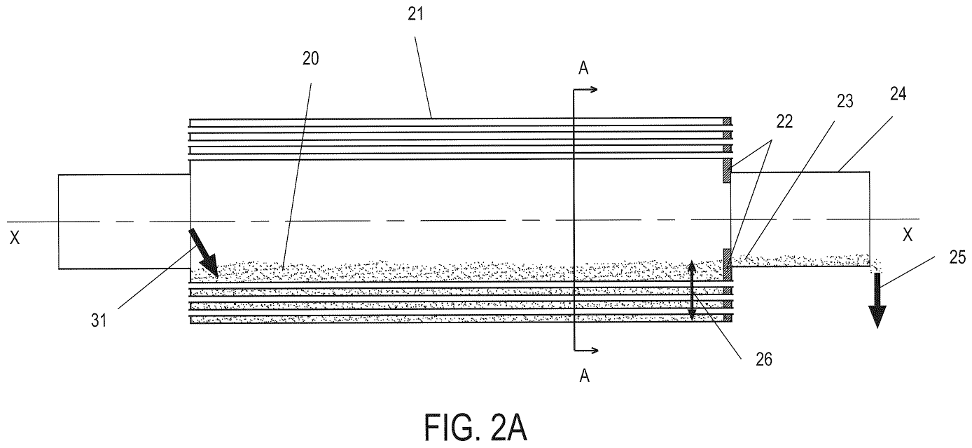

In accordance with certain embodiments, FIG. 2 is a depiction of a rotatable chamber 21 that is part of an overall system such as that depicted in FIG. 1. In certain embodiments, the rotatable chamber 21 is rotatable about longitudinal axis x-x shown in FIG. 2, such as an axis bisecting the chamber 21. In the embodiment shown, the rotatable chamber 21 contains or is adapted to contain material 20. During operation, material 20 may be continuously introduced into the rotatable chamber 21 as depicted by arrow 31 such as by a feeder, such as an infeed screw feeder (FIG. 1) or the like. In certain embodiments, one or more shovels 22 may be configured and positioned to aid in lifting material 20 from the rotatable chamber 21 and depositing it at 23 in outlet cylinder 24. As best seen in FIG. 2B, in certain embodiments a shovel 22 may be an elongated L-shaped portion terminating in a free end with a flange that cooperates with the elongated L-shaped portion to create a scoop or shovel. In certain embodiments, the material 20 travels along the bottom of outlet cylinder 24 until it discharges at an outlet such as by dropping out at 25 of an outlet cylinder 24. For example, material 20 continuously discharges at 25 from the rotatable chamber 21.

The discharge rate, R_{d}(kg/h), that the material 20 exits at 25 the rotatable chamber 21 depends on the depth d(m) 26 of material 20 in the rotatable chamber 21 and the rotational speed ω_{c} (revolutions per minute, rpm) 28 of the rotatable chamber 21. The depth 26 of material 20 in the rotatable chamber 21 is directly related to the quantity or mass of material 20, termed m_{c} (kg), inside the rotatable chamber 21. The quantity or mass of material m_{c} 20 in rotatable chamber 21 vs. depth d(m) can be calculated by straightforward geometrical calculations. For a rotatable chamber of length Iₒ(m) and radius rₒ(m) filled with material 20 of density ρₘ (kg/m³), the equation below will give the mass m_{c} of material 20 in the chamber 21.

$${m}_{c} = {ρ}_{m} * {l}_{o} * {r}_{o}^{2} * {cos}^{- 1} ( 1 - d / {r}_{o} ) - ( 1 - d / {r}_{o} ) * sin [ {cos}^{- 1} ( 1 - d / {r}_{o} ) ]$$

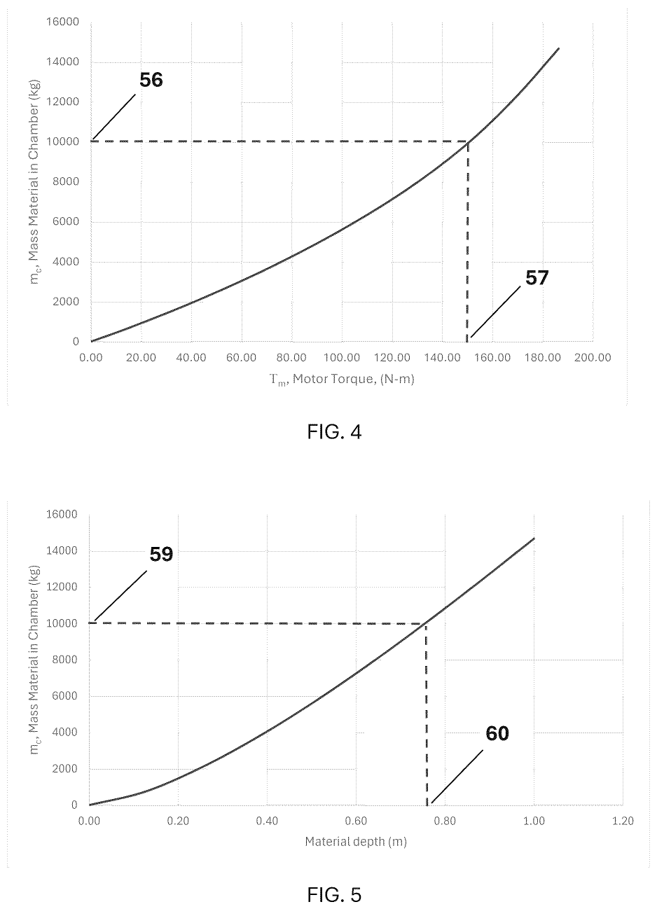

FIG. 5 shows results of such calculations for a Rotary Preheater of typical size according to the following dimensions and material parameters:

$$Radius of Chamber = {r}_{o} = 1.25 m$$

$$Length of Chamber = {l}_{o} = 5. m$$

$$Density of Material Fill = {ρ}_{m} = 1700 kg / {m}^{3}$$

$$Angle of Repose of Material = {θ}_{r} = 35 °$$

$$Reduction Ratio of Drive Equipment = {N}_{r} = 300$$

In this example, a chamber filled with 10000 kg 59 will have a material depth 60 of 0.76 m.

If the amount of material 20 inside the chamber 21 is constant, the discharge rate R_{d} at 25 is then linearly related to the rotational speed 28 of the chamber 21 and can be calculated as follows:

$${R}_{d} = Constant * {ω}_{c}$$

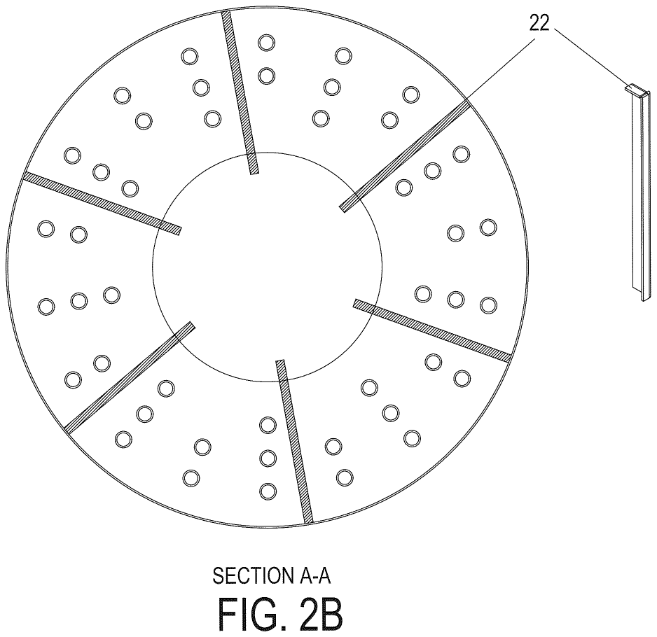

With reference to FIG. 3A, discussion is made about material fill physics. Necessarily, the material is dry and free flowing. As the chamber 21 is rotated as depicted by arrow 28, the material 20 is carried as shown by arrow 32 with the rotation until the surface of the material 33 reaches its angle of repose Or. Material will then slide over the surface as illustrated at 34 until it reaches the bottom 35 of the surface. Because of the angle of repose/sliding action of the material, the profile of material fill will remain the same, no matter how fast the chamber is rotating.

The mass m_{c} of material 20 in the chamber is not directly measurable, so it is not possible to use this parameter in a control scheme. However, because of the above-described material movement, a measurable parameter can be found that is related directly to the amount of material m_{c}.

Referring to FIG. 3B, for analysis the material center of mass Cₘ is identified. The center of mass is a distance r_{c} from the center of the rotatable chamber 21. Then gravity acts on the material with a force F_{g}.

$${F}_{g} = {m}_{c} * g$$

where m_{c} is the mass of material in the chamber and g (=9.8 N/kg) is the gravitational constant. Vector analysis may be used to breakdown the force into two perpendicular components, the radial force Fᵣ and the tangential force Fₜ:

$${F}_{t} = {F}_{g} * sin {θ}_{r}$$

$${F}_{r} = {F}_{g} * cos {θ}_{r}$$

The torque required to elevate the material m_{c} in the rotatable chamber 21 is defined as T_{c} where:

$${T}_{c} = {F}_{t} * {r}_{c} = {m}_{c} * g * sin {θ}_{r} * {r}_{c}$$

It can thus be seen that the torque T_{c} is monotonically related to the mass of material m_{c} in the chamber 21. Since the profile of material due to angle of repose is not affected by rotational speed, the torque is independent or of rotational speed ω_{c}. As a result, if constant torque T_{c} on the rotatable chamber 21 is maintained, constant m_{c} will be maintained.

Drive motor M1 torque Tₘ can sometimes be output directly from the motor variable frequency drive D1. Otherwise, motor torque can be calculated from the power Pₘ (KW) and rotational frequency ωₘ (rpm) of the motor according to the following equation, both parameters that are commonly available from the variable frequency drive D1:

$${T}_{m} ( N - m ) = 9549 * {P}_{m} ( kW ) / {ω}_{m} ( rpm )$$

In certain embodiments, the motor M1 driving the rotatable chamber 21 is operatively connected to the chamber such as by a system of gears, chains, and sprockets 39 with a speed reduction ratio of Nᵣ. Every revolution of the rotatable chamber 21 requires Nᵣ revolutions of the drive motor M1. Then the rotatable chamber 21 torque is related to the motor M1 torque as follows:

$${T}_{c} = {N}_{r} * {T}_{m}$$

Using the above equations, the quantity m_{c} of material in chamber 21 vs. motor torque, Tₘ, for the Rotary Preheater of typical size detailed above can be determined.

FIG. 3B shows the geometric relationships which allow us to calculate T_{c} for a given amount of material fill m_{c} in the chamber. The center of mass Cₘ will be the centroid of shaded region 20 (the material fill). Determination of the centroid of complex shapes is well developed in mathematics, generally determined by the method of composite parts or by calculating the first moment integral of the shape. Once the centroid of the shape is determined, we can calculate the distance r_{c} of Cₘ from the center of the chamber. Then calculate the motor torque by combining above equations:

$${T}_{m} = [ {m}_{c} * g * sin {θ}_{r} * {r}_{c} ] / {N}_{r}$$

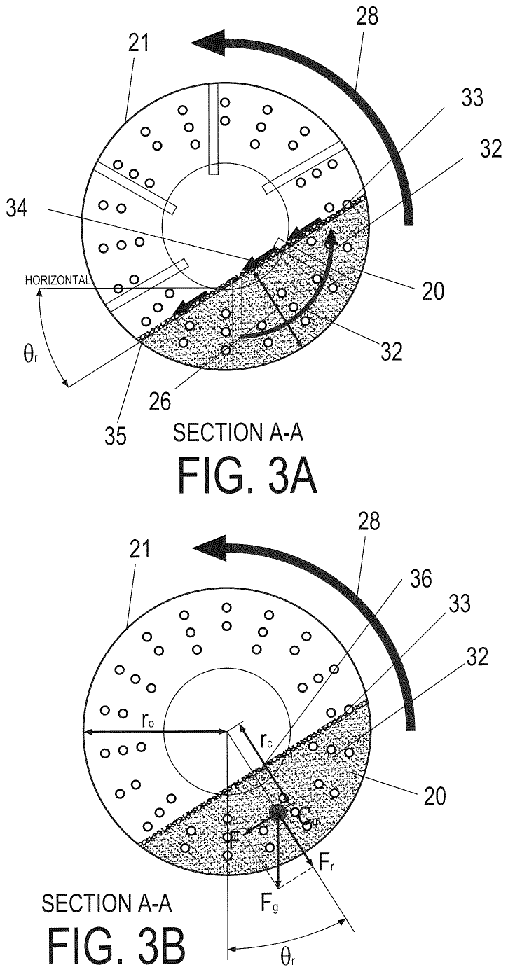

Using the sample parameters detailed above and a drive reduction ratio Nᵣ=300, a graph of m_{c} vs. Tₘ is shown in FIG. 4. Similar graphs can be produced for different sets of dimensions and parameters, but the principles and shape of the curve will be the same. From this graph, the calculated (e.g., such as with the variable frequency drive D1 from the measured power and speed) motor torque Tₘ can be used to determine the amount m_{c} of material 20 in the chamber 21. The relationship between them is monotonic, so Tₘ can be used as a controlling proxy for m_{c}.

It is important for the operation and control of the preheater that the amount m_{c} of material in the chamber 21 be maintained at the proper level and remain constant or substantially constant (e.g., as close to constant as possible within the variations inherent in the PID controller).
If m_{c} is too large, the level of material in the chamber 21 will be so high that discharge from the feeder 30 will be blocked.
If m_{c} is constant or substantially constant, then the discharge rate R_{d} will be proportional to the chamber rotational velocity ω_{c}, enabling the entire control scheme presented here.
If m_{c} is too low, ω_{c} will need to be excessive to achieve an acceptable discharge rate.
If m_{c} is held at its optimum level (e.g., as much mass as possible without blocking the infeed), the heat transfer to the material will be optimized.

A description of the preheater system in accordance with certain embodiments is now presented with reference to FIG. 1. Glass furnace 1 is shown filled with molten glass 2 up to a level 5. Molten glass continuously exits the furnace through an orifice 4, called the throat. The rate of molten glass flow 3 is critical to proper performance of downstream forming machines (e.g., molten glass flows into a bottle making machine that runs a constant mass feed rate. For a given bottle size and machine speed, the mass rate will be constant. Periodically the machine setup is converted a different bottle size and speed, then the mass rate will change (then fixed at the new production rate)), so it must be carefully controlled. The flow rate through the orifice 4 is due to gravity, so it is dependent on the level 5 of glass in the furnace and the viscosity of the molten glass. To this end, the glass level 5-must be carefully controlled to remain constant as raw material is fed at 6 into the furnace 1 and molten glass flows out of the furnace 1. A level measurer 7 may be provided to measure the glass level. The level measurer 7 can be based on one of several technical principles, e.g. mechanical, optical (e.g., laser), sound (e.g., radar), etc. In certain embodiments, the device generates an electrical signal 8 proportional to or indicative of the glass level 5 in the glass furnace 1.

In certain embodiments, a feeder 9, such as a mechanical feeder is provided to continuously feed material 6 into the furnace 1. The feeder 9 can be, for example, a screw feeder (shown), a vibrating feeder, a mechanical pusher, etc. The feeder may be equipped with a feeder driver 10, such as the motor shown, that can be adjusted such as by a variable intensity device D3 to vary the feed rate 6. An electrical driver 16, such as a variable frequency inverter, energizes driver 10 to variable speed operation, thus varying feed rate 6. A controller C3 is provided and is in electrical communication with the level measurer 7 and the variable intensity drive D3 to receive the electrical signal 8 indicative of the glass level 5 and issue speed command 19 to the variable intensity drive D3. A set point 18 of glass level is established by the operator such as based on furnace design, SP_{gl} and is inputted into a processor of the controller C1. If the measured level signal 8 is greater than set point SP_{gl}, then controller C1 is programmed to decrease speed command 19 to the variable intensity drive D3. If the measured level signal 8 is less than the set point SP_{gl}, then the controller C1 is programmed to increase speed command 19 to the variable intensity drive D3. In this way, the speed of driver 10 will be adjusted up or down until the level 5 in furnace 1 is at the desired point.

In certain embodiments, this is done with an algorithm termed PID control, which is well known in the industry, using a Process Variable (PV), Control Variable (CV) and Set Point (SP). In certain embodiments:
Process Variable (PV) is the glass level signal 8
Control Variable (CV) is the speed command 19
Set point (SP) is SP_{gl} 18.

In certain embodiments, discharge hopper 11 contains material 12 and is configured (e.g., in communication with feeder 9) to provide material 12 to feeder 9 as required. During operation, it is important that hopper 11 always contain material 12 and not run empty. Level measurer 14 associated with hopper 11 measures the level 13 of material 12 in hopper 11. Such devices can be for example, mechanical-based, sound-based (e.g., radar), optical-based (e.g., laser), a load cell, etc. Level measurer 14 generates a signal 15 (e.g., an electrical signal) proportional to or indicative of the measured level 13.

In certain embodiments, hot inlet gases 40 enter heat exchanger 45 and are passed through one or more tubes 42 of rotatable chamber 21, as shown at 41. Cooled gases 43 exit the one or more tubes 42 and are directed out of the heat exchanger 45 as shown by arrow 44. As infeed material 31 at an initial temperature of 20° C., for example, is heated in the heat exchanger 45, water is boiled from the material 31 and water vapor is continually added to the inside of the rotatable chamber 21, building pressure inside. Discharge plenum 26 in fluid communication with the rotatable chamber 21 serves to collect the discharged material mixture 25 and direct it to hopper 11 such as through chute 27. In certain embodiments, this plenum 26 is sealed to outlet cylinder 24 and to hopper 12 to prevent air infiltration or leakage out of water vapor. The pressure generated by the creation of water vapor causes water vapor 28 (steam) to be vented from port 29.

After the water is evaporated from the material 20 in rotatable chamber 21, heat transferred from flowing hot gases at 41, 43 will provide sensible heat to the material 20 and the temperature of material 20 will increase. As the temperature of material 20 increases, impurities from the Post-Consumer Recycle cullet in the material will volatilize, creating organic fumes and aerosols. The organic fumes and aerosols will accumulate inside rotatable chamber 21 and be vented as shown by arrow 28 along with water vapor out of port 29. If material 20 is heated to greater than 300° C., virtually all the organic impurities in the Post-Consumer Recycle cullet will be volatilized into organic fumes and aerosols and the heated material mixture 6 fed into the furnace will be free or essentially free of organic impurities.

Feeder 30 feeds material 31 into the rotatable chamber 21. Infeed hopper 46 contains material 47, delivered periodically by conveyor system 48 or the like from other material handling equipment (not shown). Feeder 30 is equipped with variable drive equipment to allow the feed rate of infeed material 31 to be varied. This infeed rate will be adjusted to maintain a specified amount m_{c} of material 20 in the rotatable chamber 21. The example described here is for a rotatable auger 52 screw feeder with motor 50, but other types of feeders could be employed, such as a vibratory feeder or mechanical pusher, for example.

Feeder 30 is driven by motor M2. Motor M2 is equipped with or associated with a variable frequency drive D2 that specifies rotation of the screw feed auger and allows it to be varied. A controller C2 provides a speed command 54 to drive D2. As determined above, the rotatable chamber motor torque Tₘ is directly and monotonically related to the amount of material m_{c} in the rotatable chamber 21. As such, the feeder 30 speed is controlled to maintain a constant value of Tₘ, thus also controlling to maintain constant m_{c}. As an example we detail a PID controller to achieve such purpose where:

$$PV = torque signal 55$$

$$CV = speed command 54$$

$$SP = 58 torque level corresponding to desired {m}_{c} according to the data in FIG .$$

4, which is programmed in the a processor associated with controller C2.

For example, with reference to FIG. 4, for a desired amount 56 of 10000 kg in the rotatable chamber 21, the motor torque set point 58 will be 150 N-m. Then motor 50 speed 54 will be adjusted downward if torque signal 55 is above the torque set point 58. Motor 50 speed will be adjusted upward if torque signal 55 is below the torque set point 58.

Discharge Hopper 11 contains material 12 configured (e.g., in communication with feeder 9) to provide material to feeder 9 as required. During operation, it is important that hopper 11 always contain material 12 and not run empty. Level measurer 14 measures level 13 of material 12 in hopper 11. Such devices can be, for example, mechanical-based, sound-based (e.g., radar), optical-based (e.g., laser), a load cell, etc. Level measurer 14 generates a signal 15, such as an electrical signal, proportional to or indicative of the measured level 13.

As described previously, rotatable chamber 21 delivers material to the discharge hopper 11 at discharge rate Rd. If the depth of material in the chamber 21 is constant, the discharge rate 25 is proportional to the rotational rate ω_{c} (revolutions per minute, rpm) of the rotatable chamber 21. A controller C1 is provided to (e.g., is in electrical communication with the level measurer 14) level signal 15 and produce a speed command 62 to drive D1. The chamber 21 rotational speed may be controlled to maintain a constant value of Lₕ. As an example we detail a PID controller to achieve such purpose where:

$$PV = level signal 15$$

$$CV = speed command 62$$

$$SP = 63 hopper level corresponding to desired point$$

Then motor 38 speed 62 will be adjusted downward if level signal 15 is above the level set point 63. Motor 38 speed will be adjusted upward if level signal 15 is below the set point 63.

What is claimed is:

1. A control system for controlling the amount of material fed to a glass furnace from a rotatable chamber of a rotary heat-exchanger having a rotatable chamber variable frequency drive in communication with a rotatable chamber motor for rotating said rotatable chamber, the control system comprising:
a material feeder in communication with said rotatable chamber;
a driver for said material feeder including a feeder variable frequency drive and a feeder motor associated with the feeder variable frequency drive;
a controller in communication with said feeder variable frequency drive and with said chamber variable frequency drive and configured to modify the speed of said material feeder in response to a signal generated by said chamber variable frequency drive indicative of a torque required to rotate said rotatable chamber.

2. A control system for controlling the amount of material fed to a glass furnace from a rotatable chamber of a rotary heat-exchanger wherein a discharge hopper is in communication with said rotatable chamber having a rotatable chamber variable frequency drive in communication with a rotatable chamber motor for rotating said rotatable chamber and with said glass furnace, said control system comprising:
a hopper level measurer configured to measure the level of said material in said discharge hopper;
wherein said controller is in communication with said hopper level measurer and with said rotatable chamber variable frequency drive and is configured to modify the speed of said rotatable chamber in response to a signal generated by said hopper level measurer indicative of the level of said material in said discharge hopper.

3. The control system of claim 1, further comprising:
a glass furnace measure leveler configured to measure the level of said material in said glass furnace; and
a glass furnace feeder in communication with said discharge hopper and with said glass furnace and having a glass furnace feeder driver;
wherein said controller is in communication with said glass furnace level measurer and with said glass furnace feeder driver and is configured to modify the speed of said glass furnace feeder driver in response to a signal generated by said glass furnace measure leveler indicative of the level of said material in said glass furnace.

4. The control system of claim 1, further comprising a discharge hopper in communication with said rotatable chamber and with said glass furnace, said control system still further comprising:
a hopper level measurer configured to measure the level of said material in said discharge hopper;
wherein said controller is in communication with said hopper level measurer and with said rotatable chamber variable frequency drive and is configured to modify the speed of said rotatable chamber in response to a signal generated by said hopper level measurer indicative of the level of said material in said discharge hopper.

5. The control system of claim 4, further comprising:
a glass furnace measure leveler configured to measure the level of said material in said glass furnace; and
a glass furnace feeder in communication with said discharge hopper and with said glass furnace and having a glass furnace feeder driver;
wherein said controller is in communication with said glass furnace level measurer and with said glass furnace feeder driver and is configured to modify the speed of said glass furnace feeder driver in response to a signal generated by said glass furnace measure leveler indicative of the level of said material in said glass furnace.

6. A method for controlling the amount of material fed to a glass furnace from a rotatable chamber of a rotary heat-exchanger having a rotatable chamber variable frequency drive in communication with a rotatable chamber motor for rotating said rotatable chamber, the method comprising:
generating a signal with said chamber variable frequency drive indicative of a torque required to rotate said rotatable chamber;
driving a material feeder having a feeder variable frequency drive and a motor associated with said variable frequency drive to feed said material into said rotatable chamber;
controlling the speed of said material feeder with said variable frequency drive in response to the sensed signal indicative of said torque.

7. The method of claim 6, wherein a discharge hopper is in communication with said rotatable chamber and with said glass furnace, said method further comprising:
measuring the level of said material in said discharge hopper; and
controlling the speed of said rotatable chamber in response to a signal generated by said hopper level measurer indicative of the level of said material in said discharge hopper by controlling said chamber variable frequency drive.

8. The method of claim 6, further comprising:
measuring the level of said material in said glass furnace; and
feeding said material into said glass furnace with a glass furnace feeder in communication with said discharge hopper and with said glass furnace, said glass furnace feeder having a glass furnace feeder driver; and
controlling the speed of said glass furnace feeder driver in response to said measured level of material in said glass furnace.

9. The method of claim 7, further comprising:
measuring the level of said material in said glass furnace; and
feeding said material into said glass furnace with a glass furnace feeder in communication with said discharge hopper and with said glass furnace, said glass furnace feeder having a glass furnace feeder driver; and
controlling the speed of said glass furnace feeder driver in response to said measured level of material in said glass furnace.

10. A method for controlling the amount of material fed to a glass furnace from a rotatable chamber of a rotary heat-exchanger wherein a discharge hopper is in communication with said rotatable chamber having a rotatable chamber variable frequency drive in communication with a rotatable chamber motor for rotating said rotatable chamber and is in communication with said glass furnace, said method comprising:
measuring the level of said material in said discharge hopper; and
controlling the speed of said rotatable chamber in response to a signal generated by said hopper level measurer indicative of the level of said material in said discharge hopper by controlling said chamber variable frequency drive.

11. The method of claim 10, further comprising:
measuring the level of said material in said glass furnace; and
feeding said material into said glass furnace with a glass furnace feeder in communication with said discharge hopper and with said glass furnace, said glass furnace feeder having a glass furnace feeder driver; and
controlling the speed of said glass furnace feeder driver in response to said measured level of material in said glass furnace.
